(19) United States
(12) Patent Application Publication
(10) Pub. No.: US 2025/0266959 A1
(43) Pub. Date: Aug. 21, 2025

(54) USER EQUIPMENT SELECTION TO ASSIST COHERENT JOINT TRANSMISSION CALIBRATION

(71) Applicant: Apple Inc., Cupertino, CA (US)

(72) Inventors: Huaning Niu, San Jose, CA (US); Ankit Bhamri, Haar (DE); Chunxuan Ye, San Diego, CA (US); Dawei Zhang, Saratoga, CA (US); Haitong Sun, Saratoga, CA (US); Wei Zeng, Saratoga, CA (US); Weidong Yang, San Diego, CA (US)

(73) Assignee: Apple Inc., Cupertino, CA (US)

(21) Appl. No.: 18/949,894

(22) Filed: Nov. 15, 2024

Related U.S. Application Data
(60) Provisional application No. 63/554,104, filed on Feb. 15, 2024.

(51) Int. Cl. H04L 5/00; H04B 7/06

(52) U.S. Cl. CPC H04L 5/0051; H04B 7/0626; H04L 5/0035

(57) ABSTRACT

The present application relates to devices and components including apparatus, systems, and methods to provide user equipment assisted coherent joint transmission calibration for transmission and reception points of a network.

### CROSS-REFERENCE TO RELATED APPLICATION

This application claims priority to U.S. provisional application No. 63/554,104, entitled “User Equipment Selection to Assist Coherent Joint Transmission Calibration,” filed on Feb. 15, 2024, the disclosure of which is incorporated by reference herein in its entirety for all purposes.

### TECHNICAL FIELD

The present application relates to the field of wireless technologies and, in particular, to assisted coherent joint transmission calibration.

### BACKGROUND

Third Generation Partnership Project (3GPP) networks allow multiple transmission and reception points (TRPs) to communicate with a user equipment (UE) at a time. The UE may coherently combine transmissions from the multiple TRPs for processing. This approach may be referred to as coherent joint transmission (CJT). The multiple TRPs are assumed to be perfectly timed and synchronized to support CJT.

### BRIEF DESCRIPTION OF THE DRAWINGS

FIG. 1 illustrates an example coherent joint transmission (CJT) arrangement in accordance with some embodiments.

FIG. 2 illustrates an example network arrangement in accordance with some embodiments.

FIG. 3 illustrates a signaling chart of an example calibration reporting arrangement in accordance with some embodiments.

FIG. 4 illustrates a signaling chart of an example calibration reporting arrangement in accordance with some embodiments.

FIG. 5 illustrates an example otherConfig information element in accordance with some embodiments.

FIG. 6 illustrates an example network arrangement in accordance with some embodiments.

FIG. 7 illustrates an example network arrangement in accordance with some embodiments.

FIG. 8 illustrates an example procedure for providing CJT calibration assistance in accordance with some embodiments.

FIG. 9 illustrates an example procedure for configuring for CJT calibration assistance in accordance with some embodiments.

FIG. 10 illustrates an example procedure for providing CJT calibration assistance in accordance with some embodiments.

FIG. 11 illustrates an example user equipment (UE) in accordance with some embodiments.

FIG. 12 illustrates an example base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Release 18 (Rel-18) Type II codebook enhancement was introduced for coherent joint transmission (CJT) multi-transmission and reception point (TRP) Rel-18 supported the enhancement of the following codebooks: Rel-16 eType-II regular codebook, i.e., “typeII-r16;” and Rel-17 FeType-II port selection (PS) codebook, i.e., “typeII-PortSelection-r17.” Rel-18 supports a number of TRPs of N_{TRP}={1, 2, 3, 4} for CJT CSI report and rank index (RI) of RI={1, 2, 3, 4} for CJT CSI report.

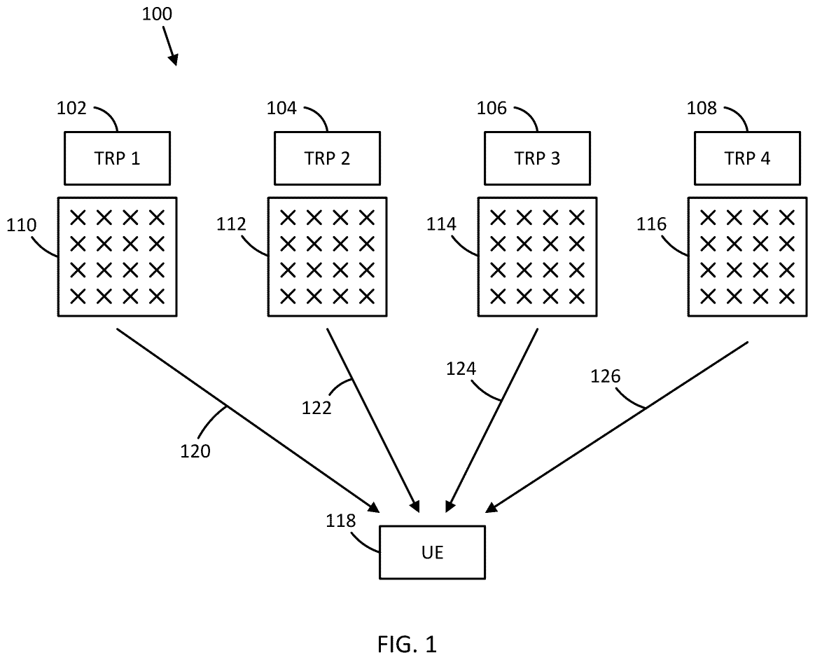

FIG. 1 illustrates an example CJT arrangement 100 in accordance with some embodiments. The CJT arrangement 100 shows a portion of a network to illustrate some of the principles that may be implemented by CJT operation.

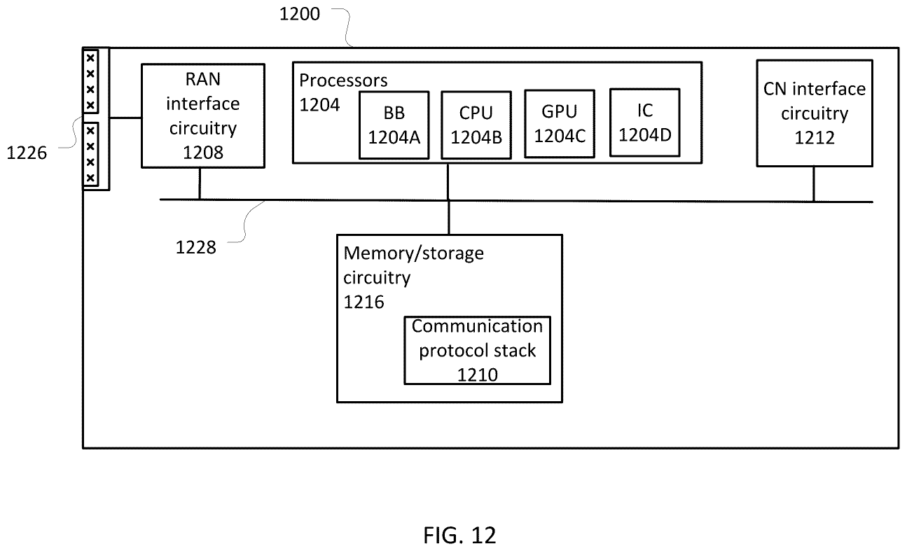

The CJT arrangement 100 may include one or more TRPs. For example, the CJT arrangement 100 includes a first TRP 102, a second TRP 104, a third TRP 106, and a fourth TRP 108. Accordingly, there are four TRPs in the illustrated embodiment. Each of the TRPs may include a base station (such as the base station 1200 (FIG. 12)) and/or one or more of the features of a base station.

Each of the TRPs may include one or more antenna panels. For example, the first TRP 102 includes a first antenna panel 110, the second TRP 104 includes a second antenna panel 112, the third TRP 106 includes a third antenna panel 114, and the fourth TRP 108 includes a fourth antenna panel 116 in the illustrated embodiment. Each of the antenna panels may include one or more antenna elements. The antenna elements may have one or both of vertical polarization and horizontal polarization. In the illustrated embodiment, the antenna elements have both vertical and horizontal polarizations as illustrated by the ‘X’s within the antenna panels. In the illustrated embodiment, each of the antenna panels may include sixteen vertical polarization elements and sixteen horizonal polarization elements. The antenna elements for each antenna panel may be grouped into eight ports, such that there are a total of 32 ports in the illustrated embodiment.

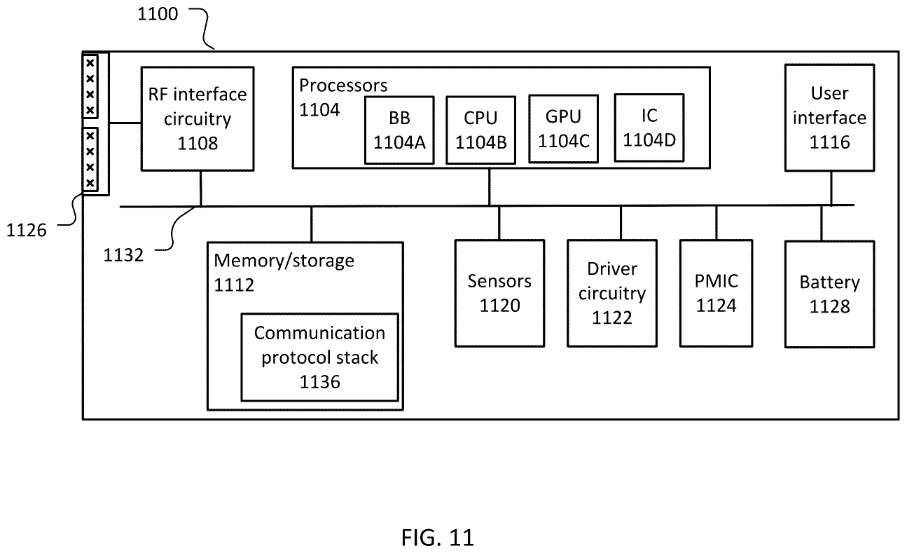

The CJT arrangement 100 may include one or more UEs. In the illustrated embodiment, the CJT arrangement 100 includes a UE 118. The UE 118 may include one or more of the features of the UE 1100 (FIG. 11). The UE 118 may have connections established with the TRPs. For example, the UE 118 has a first connection 120 established with the first TRP 102, a second connection 122 established with the second TRP 104, a third connection 124 established with the third TRP 106, and a fourth connection 126 established with the fourth TRP 108 in the illustrated embodiment. Each of the TRPs may generate and/or transmit transmissions to the UE 118, where at least a portion of the transmissions from different TRPs may be combined by the UE 118. The UE 118 may coherently combine the portion of the transmissions received from each of the TRPs.

In release (R18) multiple input multiple output (MIMO), ideal backhaul is assumed. In particular, it is assumed in R18 that there is no phase mismatch and no delay mismatch for transmissions by multiple TRPs to a single TRP that are to be combined. For example, transmissions from the first TRP 102, the second TRP 104, the third TRP 106, and/or the fourth TRP 108 that are to be combined by the UE 118 may be assumed to have no phase mismatch and no delay mismatch in R18. However, in reality there is always some time and frequency mismatch between different TRPs. Legacy approaches performed calibration between different TRPs, but the calibration was difficult. These legacy approaches relied on the TRPs performing calibration without UE feedback.

Approaches described herein can utilize feedback from one or more UEs for calibration for CJT. Utilizing feedback from the UEs can provide for more accurate calibration and/or improved CJT operation as compared to legacy approaches for calibrating CJT.

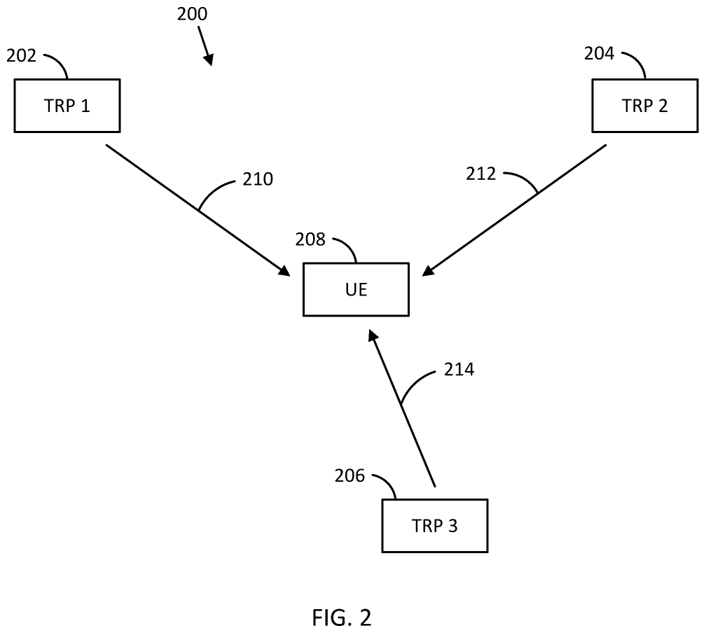

FIG. 2 illustrates an example network arrangement 200 in accordance with some embodiments. The network arrangement 200 illustrates a portion of a network that may implement CJT. The network arrangement 200 may implement an R18 approach to CJT to illustrate some of the features of the R18 approach.

The network arrangement 200 may include a first TRP 202, a second TRP 204, and a third TRP 206. Each of the first TRP 202, the second TRP 204, and the third TRP 206 may include one or more of the features of the TRPs of FIG. 1 and/or the base station 1200 (FIG. 12).

The network arrangement 200 may include a UE 208. The UE 208 may include one or more of the features of the UE 118 (FIG. 1) and/or the UE 1100 (FIG. 11).

The UE 208 may be connected with the first TRP 202, the second TRP 204, and the third TRP 206. A first path 210 may be established between the UE 208 and the first TRP 202, a second path 212 may be established between the UE 208 and the second TRP 204, and a third path 214 may be established between the UE 208 and the third TRP 206. The TRPs and the UE 208 may exchange transmissions via the paths.

In R18 MIMO, ideal backhaul may be assumed. For example, the arriving path from different TRPs only accounts for propagation delay in R18. Therefore, the first TRP 202 may only account for propagation delay on the first path 210, the second TRP 204 may only account for propagation delay on the second path 212, and the third TRP 206 may only account for propagation delay on the third path 214. The equivalent channel is multiple path channel with longer delay. As long as it is within the cyclic prefix (CP), demodulation performance is not impacted. When non-ideal backhaul is used, time and frequency offset between TRPs will degrade the performance in the R18 approach.

CJT/downlink (DL) multi-TRP enhancements may be introduced. An objective may be UE-assisted calibration reporting of delay and frequency/phase offsets for CJT with non-ideal synchronization and backhaul. Legacy channel state information (CSI)-reference signal (RS) design and standalone aperiodic reporting on physical uplink shared channel (PUSCH) may be assumed.

For the delay/frequency offset, there may be two components. The first component may be due to frequency difference between two frequency synthesizers, which are inherent in the hardware implementation. The delay and frequency offset caused in this component may cell specific.

The second component may be due to Doppler effect, which depends on the UE velocity. The frequency offset in this component may be UE specific. Depending on the carrier frequency and BTS frequency accuracy requirement, the frequency difference between two frequency synthesizers or the Doppler effect may be the dominant factor. Approaches described herein may focus on the delay and frequency/phase offset caused by the frequency difference between frequency synthesizers.

Approaches described herein include methods and procedures that may identify and select the UE to provide the assisted calibration feedback.

The procedure of over the air calibration for NW side implementation may address imperfections. A UE may generate and transmit a preference report for calibration assistance. The preference report from a UE may indicate a preference of the UE whether to provide feedback for CJT calibration. The preference of the UE whether to provide feedback for the CJT calibration may be determined based on the UE capability, the cell condition (including signal to noise ratio (SNR), signal to interference and noise ratio (SINR), and/or reference signal received power (RSRP) to different TRP), and/or a mobility condition of the UE.

The network (NW) may select and configure UE for calibration report. For example, a TRP (such as the TRPs described in FIG. 1 and/or FIG. 2 and/or the base station 1200 (FIG. 12)), and/or a core network may select one or more UEs to provide calibration reports for CJT calibration assistance. The TRP and/or the core network may select the one or more UEs based on SNR conditions, SINR conditions, and/or RSRP conditions of the one or more UEs, and/or timing advance (TA) conditions of the one or more UEs.

The one or more UEs may be configured send report back to NW. For example, the TRP and/or the core network may configure the UEs to generate and/or transmit a calibration report back to the TRP.

The NW may calculate one cell specific time/delay based on multiple UE feedbacks. For example, the TRP and/or the core network may calculate a time/delay based on information included in the calibration reports received back from the one or more UEs. The calculated time/delay may be utilized for calibrating one or more TRPs for transmitting transmissions for CJT. Performance monitoring may be performed to ensure the accuracy of UE feedback.

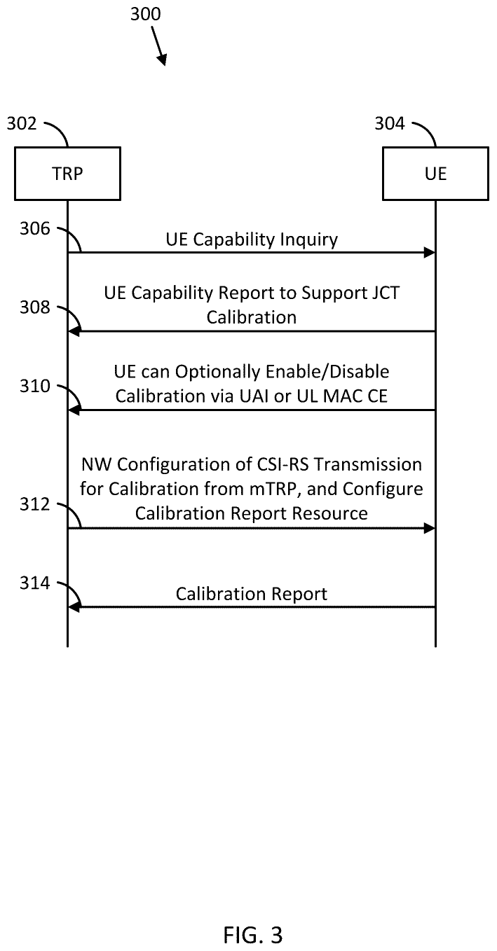

FIG. 3 illustrates a signaling chart of an example calibration reporting arrangement 300 in accordance with some embodiments. The calibration reporting arrangement 300 may implement UE feedback for assisting in CJT calibration.

The calibration reporting arrangement 300 may include a TRP 302. The TRP 302 may include one or more of the features of the TRPs described in relation to FIG. 1 and/or FIG. 2, and/or the base station 1200 (FIG. 12).

The calibration reporting arrangement 300 may include a UE 304. The UE 304 may include one or more of the features of the UE 118 (FIG. 1), the UE 208 (FIG. 2), and/or the UE 1100 (FIG. 11). The UE 304 may have a connection established with the TRP 302.

The TRP 302 may generate and/or transmit a UE capability inquiry 306 to the UE 304. The UE capability inquiry 306 may include a request for the UE 304 to report whether the UE 304 is capable to support CJT calibration. In some embodiments, the TRP 302 may generate and/or transmit the UE capability inquiry 306 in response to and/or as part of a connection establishment procedure between the TRP 302 and the UE 304. In some embodiments, the TRP 302 may generate and/or transmit the UE capability inquiry 306 based on a determination by the TRP 302 and/or the core network that calibration is desired for the TRP 302.

The UE 304 may generate and/or transmit a UE capability report 308 to the TRP 302. The UE capability report 308 may include an indication of whether the UE 304 supports the calibration information report feature. For example, the UE capability report 308 may indicate whether or not the UE 304 is capable of supporting CJT calibration. Optionally, the UE 304 can send the UE capability report 308 related to calibration after NW configured the need for calibration. For example, the UE 304 may generate and/or transmit the UE capability report 308 based on the UE capability inquiry 306 received from the TRP 302, where the UE capability inquiry 306 may have been transmitted based on the connection establishment procedure or the desire for calibration of the TRP 302. If the UE capability report 308 indicates that the UE 304 does not have the capability to support CJT calibration, the TRP 302 may determine that the UE 304 does not have the capability and may not select the UE 304 for CJT calibration assistance. In the instance where the TRP 302 determines that the UE 304 does not have the capability, further signaling related to CJT calibration support may be omitted.

A UE is capable to support this calibration can send additional optional UE preference to perform calibration. For example, if the UE 304 is capable of supporting CJT calibration, the UE 304 may generate and/or transmit one or more preference feedback messages, such as a preference feedback message 310, to the TRP 302. The preference feedback message 310 may optionally send a request to enable or disable calibration via user equipment assistance information (UAI) or uplink (UL) medium access control (MAC) control element (CE). For example, the UE 304 may transmit the preference feedback message 310 via UAI or UL MAC CE.

If the TRP 302 and/or the core network selects the UE 304 for CJT assistance, the TRP 302 may generate and/or transmit a configuration message 312 to the UE 304. The TRP 302 and/or the core network may determine that the UE 304 has indicated capability to support JCT calibration in the UE capability report 308 and/or determine that the UE 304 has enabled calibration via the preference feedback message 310. The TRP 302 and/or the core network may select the UE 304 based on an SNR condition, an SINR condition, and/or an RSRP condition of the UE 304, a mobility condition of the UE 304, a battery condition of the UE 304, and/or a TA condition of the UE 304. For example, the TRP 302 and/or the core network may select the UE 304 based on an SNR, an SINR, or an RSRP of the UE 304 being above a first threshold. Further, the TRP 302 and/or the core network may select the UE 304 based on TAs between the UE 304 and each of the TRPs being calibrated being with a second threshold of each other. In some embodiments, the TRP 302 and/or the core network may select the UE 304 based on the mobility condition, where stationary UEs or UEs moving below a threshold movement rate are selected to minimize the impact of the Doppler effect. Further, the TRP 302 and/or the core network may select the UE 304 based on whether the UE 304 is in a power saving mode, where UEs with higher levels of battery charge can be selected before UEs with lower levels of battery charge. The configuration message 312 may include configuration for CSI-RS transmission for calibration from multi-TRP (mTRP) and/or configuration for a calibration report resource. The TRP 302 and/or the core network may configure CSI-RS transmission for calibration per TRP, and may configure calibration report resource. The configuration message 312 may cause the UE 304 to be configured to provide information for CJT calibration.

The UE 304 may perform time/delay measurement and frequency offset measurement per TRP. For example, the UE 304 may perform time/delay measurement and/or frequency offset measurement based on being configured by the configuration message 312. The UE 304 may report the measurement result back to NW. For example, the UE 304 may generate and/or transmit a calibration report 314 to the TRP 302. The calibration report 314 may include the measurement results of the time/delay measurement and/or the frequency offset measurement.

The TRP 302 may identify the calibration report 314 received from the UE 304. The TRP 302 and/or the core network may utilize the measurement results from the calibration report 314 to calibrate one or more TRPs for CJT.

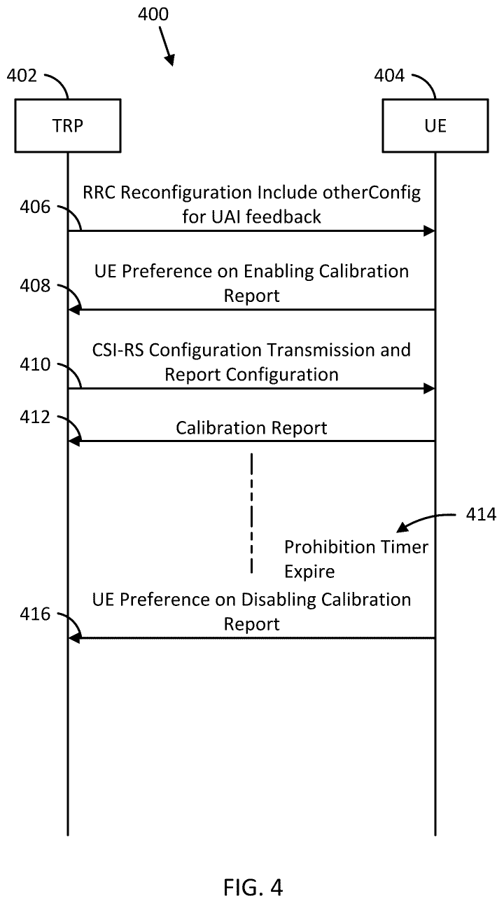

FIG. 4 illustrates a signaling chart of an example calibration reporting arrangement 400 in accordance with some embodiments. The calibration reporting arrangement 400 may implement UE feedback for assisting in CJT calibration. Further, the calibration reporting arrangement 400 may include an option UE request to support calibration.

The calibration reporting arrangement 400 may include a TRP 402. The TRP 402 may include one or more of the features of the TRPs described in relation to FIG. 1 and/or FIG. 2, the TRP 302 (FIG. 3), and/or the base station 1200 (FIG. 12).

The calibration reporting arrangement 400 may include a UE 404. The UE 404 may include one or more of the features of the UE 118 (FIG. 1), the UE 208 (FIG. 2), the UE 304 (FIG. 3), and/or the UE 1100 (FIG. 11). The UE 404 may have a connection established with the TRP 402.

UAI framework can be used as baseline for the UE preference feedback. For example, the TRP 402 may generate and/or transmit a radio resource control (RRC) reconfiguration message 406 to the UE 404. The RRC reconfiguration message 406 may include an otherConfig information element. The otherConfig information element may configure the UE 404 for UAI feedback. In some embodiments, the otherConfig information element may include configuration for a prohibition timer 414.

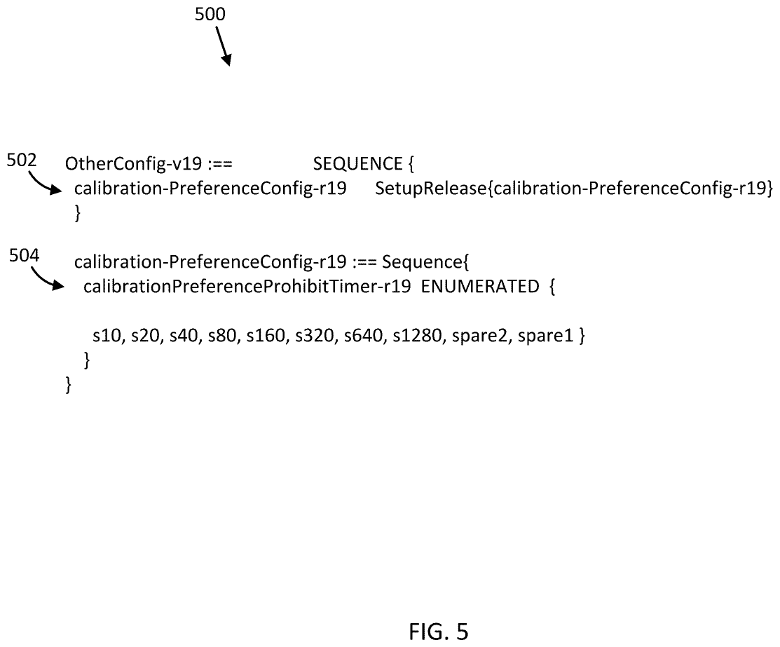

FIG. 5 illustrates an example otherConfig information element 500 in accordance with some embodiments. The otherConfig information element of the RRC reconfiguration message 406 may include one or more of the features of the otherConfig information element 500.

The otherConfig information element 500 may include a preference configuration information element 502. The preference configuration information element 502 may provide configuration information to configure a UE to provide preference feedback for supporting CJT calibration.

The otherConfig information element 500 may include a prohibition timer information element 504. The prohibition timer information element 504 may provide configuration information to configure a UE with a prohibition timer related to the preference feedback. The prohibition timer may define a time after a UE transmits a preference feedback message that the UE is prohibited from another providing preference feedback message.

A UE may be allowed to feedback preference configuration to support the NW calibration report. For example, the UE 404 may generate and/or transmit a preference feedback message 408 to the TRP 402. The preference feedback message 408 may provide UE feedback preference to assisted NW side calibration. For example, the preference feedback message 408 may indicate a UE preference on enabling calibration report for CJT calibration. Some measurement configuration and report configuration can potentially be sent by the UE.

UE can send preference based on following considerations. For example, the UE 404 may generate and/or provide the preference feedback message 408 based on one or more of the following considerations. The first consideration may include good SINR/SNR condition to all the TRPs for more accurate time/frequency offset estimation. For the first consideration, the UE 404 may determine whether the SINR and/or the SNR of the UE 404 is greater than a first threshold value. The second consideration may include UE is not UE power saving mode (enough battery). For the second consideration, the UE 404 may determine whether a charge status (which may be a battery level) of the UE 404 is above a second threshold. The third consideration may include low mobility and static channel change during calibration measurement). For the third consideration, the UE 404 may determine whether a mobility status (which may be rate of speed at which the UE 404 is moving) is below a third threshold, and/or where a channel status (which may be a quality of service of a channel) is above a fourth threshold. In the illustrated embodiment, the preference feedback message 408 indicates that the UE 404 prefers enabling calibration reports.

In some embodiments, the UE 404 may generate and/or transmit the preference feedback message 408 based on the RRC reconfiguration message 406. In some embodiments, the uplink (UL) MAC CE can be used for event driven UL feedback. For example, the UE 404 generate and/or transmit the preference feedback message 408 based on occurrence of an event. The UE 404 may transmit the preference feedback message via UL MAC CE. The UL events that can trigger the preference feedback message 408 can be defined, including low mobility criterion, SINR criterion, SNR criterion and/or reference signal received power (RSRP) criterion.

If the TRP 402 and/or the core network selects the UE 404 for CJT assistance, the TRP 402 may generate and/or transmit a configuration message 410 to the UE 404. The TRP 402 and/or the core network may determine that the UE 404 has indicated a preference to support CJT calibration in the preference feedback message 408. The TRP 402 and/or the core network may select the UE 404 based on an SINR condition, an SNR condition, and/or an RSRP condition of the UE 404 and/or a TA condition of the UE 404. For example, the TRP 402 and/or the core network may select the UE 404 based on an SINR condition, an SNR, and/or an RSRP condition of the UE 404 being above a corresponding threshold. Further, the TRP 402 and/or the core network may select the UE 404 based on TAs between the UE 404 and each of the TRPs being calibrated being within a second threshold of each other. The configuration message 410 may include configuration for CSI-RS transmission for calibration from multi-TRP (mTRP) and/or configuration for a calibration report resource. The TRP 402 and/or the core network may configure CSI-RS transmission for calibration per TRP, and may configure calibration report resource. The configuration message 410 may cause the UE 404 to be configured to provide information for CJT calibration.

The UE 404 may perform time/delay measurement and frequency offset measurement per TRP. For example, the UE 404 may perform time/delay measurement and/or frequency offset measurement based on being configured by the configuration message 410. The UE 404 may report the measurement result back to NW. For example, the UE 404 may generate and/or transmit a calibration report 412 to the TRP 402. The calibration report 412 may include the measurement results of the time/delay measurement and/or the frequency offset measurement.

The TRP 402 may identify the calibration report 412 received from the UE 404. The TRP 402 and/or the core network may utilize the measurement results from the calibration report 412 to calibrate one or more TRPs for CJT.

The UE 404 may initiate a count of the prohibition timer 414 based on the calibration report 412. For example, the UE 404 may start a count of the prohibition timer 414 when the calibration report 412 is generated or transmitted. The UE 404 may be prohibited from transmitting preference feedback messages (such as the preference feedback message 408) while the prohibition timer 414 is counting. In some embodiments, the UE 404 may transmit additional calibration reports (such as the calibration report 412) while the prohibition timer 414 is counting. The UE 404 may generate and/or transmit additional calibration reports periodically, semi-persistently, and/or downlink control information (DCI) triggered aperiodically. The UE 404 may continue to generate and/or transmit additional calibration reports until the UE 404 is reconfigured not to send calibration reports and/or the preference to support CJT calibration has changed.

After expiration of the prohibition timer 414, the UE 404 may generate and/or transmit additional preference feedback messages. For example, the UE 404 transmits a second preference feedback message 416 in the illustrated embodiment. The second preference feedback message 416 may indicate that the UE 404 prefers to disable calibration reporting.

The NW can select one or more UEs for CJT calibration assistance. For example, a TRP and/or a core network may select one or more UEs from available UEs for support CJT calibration. The TRP and/or the core network may select the one or more UEs after UE capability report and optionally UE preference feedback may be provided.

The NW may select one or more UEs within the CJT region, after UE capability and UE preference report are received. The CJT region can be defined as UE with similar TA value to different TRP. For example, the TRP and/or the core network may define a CJT region as an area between the TRPs to be calibrated where the TAs to all the TRPs to be calibrated are within a threshold value of each other. The TA may be separately measured per TRP. Similar TA value can separate the aggregated delay effort. The UEs within the CJT region may have similar layer 1 (L1)-SINR report, similar L1-SNR, and/or similar L1-reference signal received power (RSRP) report.

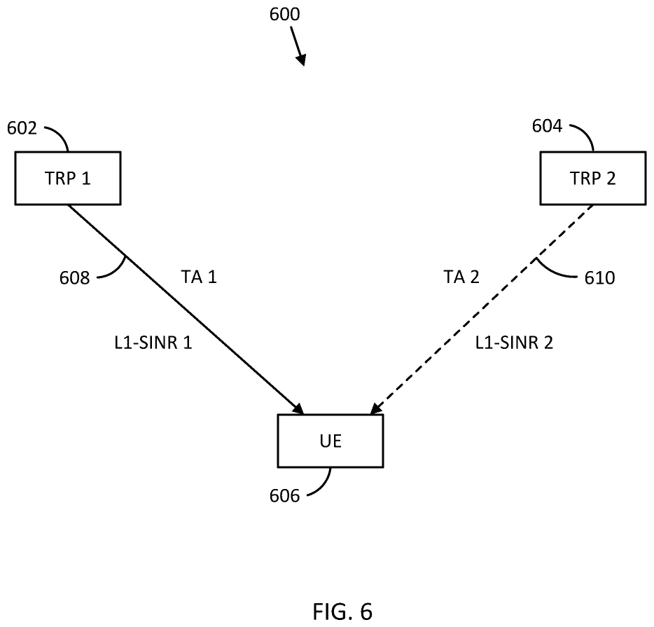

FIG. 6 illustrates an example network arrangement 600 in accordance with some embodiments. The network arrangement 600 may illustrate a portion of a network with a UE that may be selected for CJT calibration assistance.

The network arrangement 600 may include a first TRP 602 and a second TRP 604. Each of the first TRP 602 and the second TRP 604 may include one or more of the features of the TRPs of FIG. 1, the TRPs of FIG. 2, the TRP 302 (FIG. 3), the TRP 402 (FIG. 4), and/or the base station 1200 (FIG. 12). The first TRP 602 and the second TRP 604 may be configured for CJT and may support CJT calibration.

The network arrangement 600 may include a UE 606. The UE 606 may include one or more of the features of the UE 118 (FIG. 1), the UE 208 (FIG. 2), the UE 304 (FIG. 3), the UE 404 (FIG. 4), and/or the UE 1100 (FIG. 11). The UE 606 may have connections established with the first TRP 602 and the second TRP 604. For example, a first path 608 may be established between the first TRP 602 and the UE 606, and a second path 610 may be established between the second TRP 604 and the UE 606.

The UE 606 may have provided a UE capability report (such as the UE capability report 308 (FIG. 3)) and/or a preference feedback message (such as the preference feedback message 310 (FIG. 3) and/or the preference feedback message 408 (FIG. 4)) to one or both of the first TRP 602 and the second TRP 604 that indicates that the UE 606 is available to support CJT calibration. The UE 606 may have a first TA with the first TRP 602 and a second TA with the second TRP 604 that are within a threshold value of each other. The first TA and the second TA may be approximately the same based on the UE 606 being approximately a same distance from the first TRP 602 and the second TRP 604. Further, the UE 606 may have a first L1-SINR value (L1-SINR 1) with the first TRP 602 that is approximately equal to a second L1-SINR value (L1-SINR 2) with the second TRP 604. The first TRP 602, the second TRP 604, and/or the core network may select the UE 606 for providing calibration reports for CJT calibration based on the first TA and the second TA being within the threshold value.

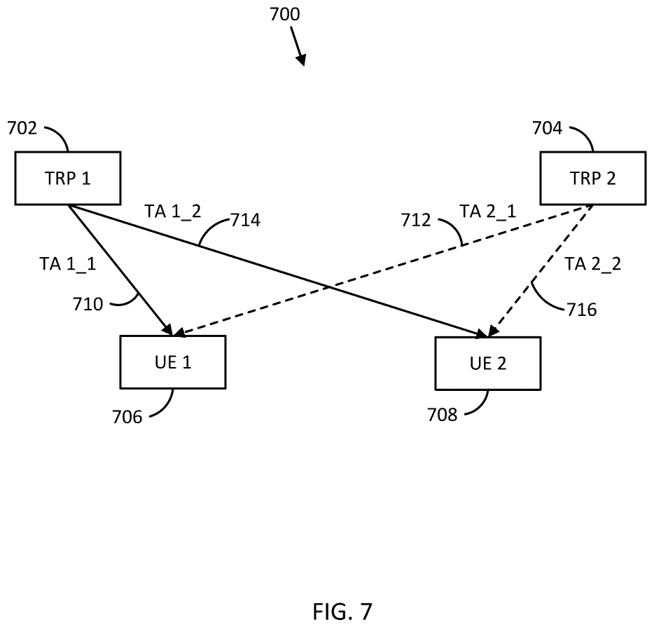

FIG. 7 illustrates an example network arrangement 700 in accordance with some embodiments. The network arrangement 700 may illustrate a portion of a network with a UE that may be selected for CJT calibration assistance.

The network arrangement 700 may include a first TRP 702 and a second TRP 704. Each of the first TRP 702 and the second TRP 704 may include one or more of the features of the TRPs of FIG. 1, the TRPs of FIG. 2, the TRP 302 (FIG. 3), the TRP 402 (FIG. 4), the first TRP 602 (FIG. 6), the second TRP 604 (FIG. 6), and/or the base station 1200 (FIG. 12). The first TRP 702 and the second TRP 704 may be configured for CJT and may support CJT calibration.

The network arrangement 700 may include a first UE 706 and a second UE 708. Each of the first UE 706 and the second UE 708 may include one or more of the features of the UE 118 (FIG. 1), the UE 208 (FIG. 2), the UE 304 (FIG. 3), the UE 404 (FIG. 4), the UE 606 (FIG. 6), and/or the UE 1100 (FIG. 11). Both the first UE 706 and the second UE 708 may have connections established with the first TRP 702 and the second TRP 704. For example, a first path 710 may be established between the first TRP 702 and the first UE 706, and a second path 712 may be established between the second TRP 704 and the first UE 706. A third path 714 may be established between the first TRP 702 and the second UE 708, and a fourth path 716 may be established between the second TRP 704 and the second UE 708.

The first UE 706 may have provided a UE capability report (such as the UE capability report 308 (FIG. 3)) and/or a preference feedback message (such as the preference feedback message 310 (FIG. 3) and/or the preference feedback message 408 (FIG. 4)) to one or both of the first TRP 702 and the second TRP 704 that indicates that the first UE 706 is available to support CJT calibration. The second UE 708 may have provided a UE capability report (such as the UE capability report 308 (FIG. 3)) and/or a preference feedback message (such as the preference feedback message 310 (FIG. 3) and/or the preference feedback message 408 (FIG. 4)) to one or both of the first TRP 702 and the second TRP 704 that indicates that the second UE 708 is available to support CJT calibration.

With large TA difference, the first UE 706 may report a positive delay of the second TRP 704 comparing to the first TRP 702, and the second UE 708 may report a negative delay of the second TRP 704 comparing to the first TRP 702. For example, a first TA between the first UE 706 and the first TRP 702 may be shorter than a second TA between the first UE 706 and the second TRP 704, such that a difference between the first TA and the second TA is larger than a threshold value. The difference between the first TA and the second TA may be based on a distance between the first UE 706 and the first TRP 702 being shorter than a distance between the first UE 706 and the second TRP 704. The large difference may result in the first UE 706 reporting a positive delay of the second TRP 704 compared to the first TRP 702. A third TA between the second UE 708 and the first TRP 702 may be longer than a fourth TA between the second UE 708 and the second TRP 704, such that a difference between the third TA and the fourth TA is larger than the threshold value. The difference between the third TA and the fourth TA may be based on a distance between the second UE 708 and the first TRP 702 being longer than a distance between the second UE 708 and the second TRP 704.

The base station may not be able to calculate accurate delay and frequency offset due to non-ideal backhaul. For example, the first TRP 702 and/or the second TRP 704 may not be able to accurately calculate the delay and/or the frequency offset for the first UE 706 and the second UE 708 due to the differences in the TAs for each being larger than the threshold value. Accordingly, the first TRP 702, the second TRP 704, and/or the core network may not select the first UE 706 and the second UE 708 for providing calibration reports based on the differences in the TAs. In particular, the first UE 706 and the second UE 708 may not be selected for CJT calibration assistance for the first TRP 702 and the second TRP 704.

The NW may calculate final time/frequency value. For example, a TRP and/or a core network can choose multiple UEs to feedback the delay and frequency/time information to assist calibration. The TRP and/or the core network may perform a simple calculation of an average of different UEs's report. The TRP and/or the core network may utilize the calculated average to calibrate the corresponding TRPs. When CJT region is large to select UEs, NW can pre-compensate the delay report by subtract the TA value. For example, the TRP and/or the core network may pre-compensate the TAs prior to averaging the values by subtracting the TA value in instances where the TA differences for the utilized UEs are above a threshold value.

For UE accuracy, when a UE has more than 1 receiver (Rx) port, the time/frequency offset may be within a minimum and maximum of all the measurement from different Rx ports. For example, a time/frequency offset measurement included in a calibration report (such the calibration report 314 (FIG. 3) and/or the calibration report 412 (FIG. 4)) by a UE having more than one Rx port may be between a minimum and a maximum value of all the measurement from the different Rx ports of the UE.

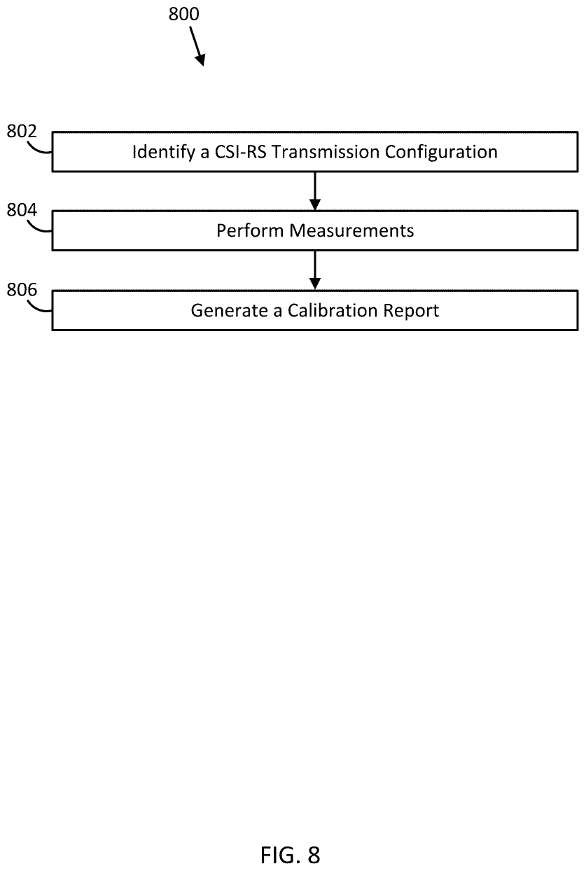

FIG. 8 illustrates an example procedure 800 for providing CJT calibration assistance in accordance with some embodiments. The procedure 800 may be performed by a UE, such as the UE 304 (FIG. 3), the UE 404 (FIG. 4), the UE 606 (FIG. 6), the first UE 706 (FIG. 7), the second UE 708 (FIG. 7), and/or the UE 1100 (FIG. 11).

The procedure 800 may include identifying a CSI-RS transmission configuration in 802. For example, the UE may identify a CSI-RS transmission configuration for CJT calibration assistance received from a base station.

In some embodiments, the procedure 800 may include identifying a CJT calibration assistance capability support inquiry received from the base station. The procedure 800 may further include determining a capability to support CJT calibration assistance. Further, the procedure 800 may generate a capability report indicating capability to support CJT calibration assistance.

In some embodiments, the procedure 800 may include identifying an event occurrence. In some embodiments, the event occurrence may include a mobility status below a first threshold, an SINR above a second threshold, an SNR above a third threshold, or an RSRP above a fourth threshold. The procedure 800 may further include generating a preference feedback message for transmission to the base station in response to the event occurrence. The preference feedback message may indicate support for CJT calibration assistance.

The procedure 800 may include performing measurements in 804. For example, the UE may perform measurements in accordance with the CSI-RS transmission configuration for CJT calibration. In some embodiments, the measurements may include time/delay measurements per TRP or frequency offset measurements per TRP.

The procedure 800 may include generating a calibration report in 806. For example, the UE may generate a calibration report indicating results of the measurements for CJT calibration for transmission to the base station.

In some embodiments, the procedure 800 may include identifying a calibration report resource configuration received from the base station. The calibration report may be generated in accordance with the calibration report resource configuration.

In some embodiments, the procedure 800 may include determining a preference for supporting CJT calibration assistance. In some embodiments, determining the preference may include determining the preference based at least in part on an SINR, an SNR, an RSRP, a charge status, a mobility status, or a channel status. The procedure 800 may further include generating a preference feedback message for transmission to the base station. The preference feedback message may indicate the preference for supporting CJT calibration assistance.

In some embodiments, the preference for supporting CJT calibration assistance may be a first preference for supporting CJT calibration assistance. Further, the preference feedback message may be a first preference feedback message in some embodiments. The procedure 800 may further include initiating a count of a prohibition timer at transmission of the calibration report. Further, the procedure 800 may include determining a second preference for supporting CJT calibration assistance after expiration of the prohibition timer. The procedure 800 may further include generating a second preference feedback message for transmission to the base station. The second preference message may indicate the second preference for supporting CJT calibration assistance.

In some embodiments, the procedure 800 may include identifying an RRC reconfiguration message that includes an otherConfig information element. The preference feedback message may be generated in accordance with information within the otherConfig information element.

Any one or more of the operations in FIG. 8 may be performed in a different order than shown and/or one or more of the operations may be performed concurrently in embodiments. Further, it should be understood that one or more of the operations may be omitted from and/or one or more additional operations may be added to the procedure 800 in other embodiments.

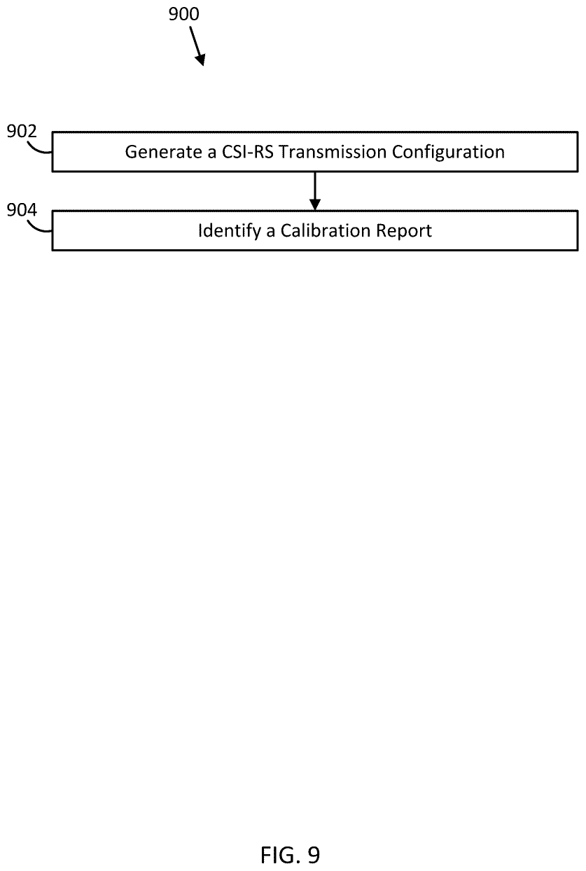

FIG. 9 illustrates an example procedure 900 for configuring for CJT calibration assistance in accordance with some embodiments. The procedure 900 may be performed by a TRP, such as the TRP 302 (FIG. 3), the TRP 402 (FIG. 4), the first TRP 602 (FIG. 6), the second TRP 604 (FIG. 6), the first TRP 702 (FIG. 7), the second TRP 704 (FIG. 7), and/or the base station 1200 (FIG. 12).

The procedure 900 may include generating a CSI-RS transmission configuration in 902. For example, the TRP may generate a CSI-RS transmission configuration for CJT calibration assistance for transmission to a UE.

In some embodiments, the procedure 900 may include generating a CJT calibration assistance capability support inquiry for transmission to the UE. In some embodiments, the procedure 900 may include identifying a capability report received from the UE. The capability report may indicate that the UE is capable of supporting CJT calibration assistance. The CSI-RS transmission configuration may be generated based at least in part on the capability report.

In some embodiments, the procedure 900 may include identifying a preference feedback message received from the UE. The preference feedback message may indicate that the UE is available for CJT calibration assistance. The CSI-RS transmission configuration may be generated based at least in part on the preference feedback message.

In some embodiments, the procedure 900 may include generating an RRC reconfiguration message that includes an otherConfig information element for transmission to the UE. The otherConfig information element may configure the UE for preference feedback. In some embodiments, the otherConfig information element may include a prohibition timer configuration.

In some embodiments, the procedure 900 may include identifying one or more UEs available for CJT calibration assistance. Further, the procedure 900 may include selecting the UE from the one or more UEs for calibrating one or more TRPs based at least in part on TA values of the UE for the one or more TRPs. The CSI-RS transmission configuration may be generated based at least in part on the UE being selected.

The procedure 900 may include identifying a calibration report in 904. For example, the TRP may identify a calibration report received from the UE. Information from the calibration report may be utilized for calibrating one or more TRPs.

In some embodiments, the procedure 900 may include generating a calibration report resource configuration for transmission to the UE. The calibration report may be generated in accordance with the calibration report resource configuration.

Any one or more of the operations in FIG. 9 may be performed in a different order than shown and/or one or more of the operations may be performed concurrently in embodiments. Further, it should be understood that one or more of the operations may be omitted from and/or one or more additional operations may be added to the procedure 900 in other embodiments.

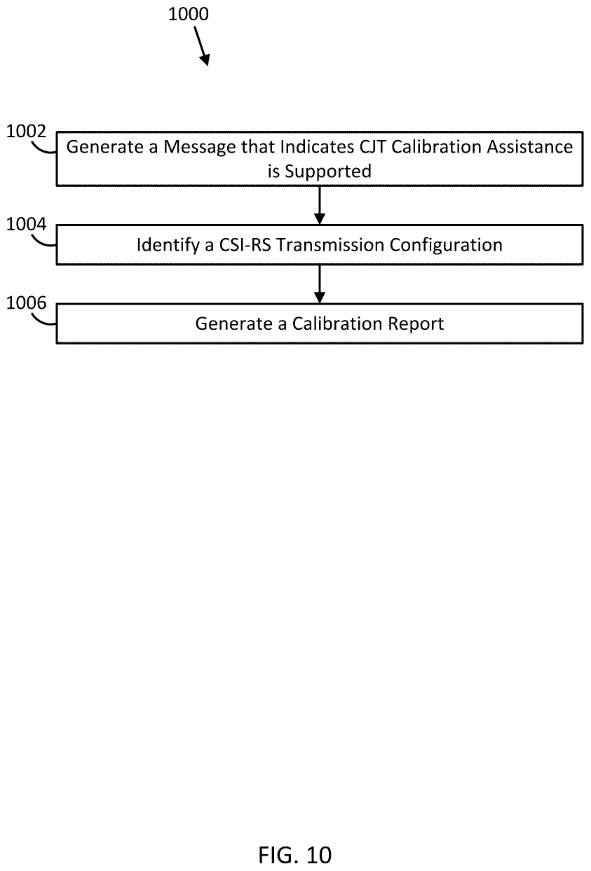

FIG. 10 illustrates an example procedure 1000 for providing CJT calibration assistance in accordance with some embodiments. The procedure 1000 may be performed by a UE, such as the UE 304 (FIG. 3), the UE 404 (FIG. 4), the UE 606 (FIG. 6), the first UE 706 (FIG. 7), the second UE 708 (FIG. 7), and/or the UE 1100 (FIG. 11).

The procedure 1000 may include generating a message that indicates CJT calibration assistance is supported in 1002. The message may be for transmission to a base station.

In some embodiments, the message may be a preference feedback message. The procedure 1000 may further include identifying an event occurrence in some embodiments. The preference feedback message may be generated based at least in part on the event occurrence. The event occurrence may include a mobility status below a first threshold, an SINR above a second threshold, an SNR above a third threshold, or an RSRP above a fourth threshold.

The procedure 1000 may include identifying a CSI-RS transmission configuration in 1004. For example, the UE may identify a CSI-RS transmission configuration for CJT calibration assistance received from the base station.

The procedure 1000 may include generating a calibration report in 1006. For example, the UE may generate a calibration report for transmission to the base station. The calibration report may include information for CJT calibration.

In some embodiments, the procedure 1000 may further include performing measurements in accordance with the CSI-RS transmission configuration for CJT calibration to produce the information included in the calibration report.

In some embodiments, the message may be a capability report. The procedure 1000 may further include identifying a CJT calibration assistance capability support inquiry received from the base station in some embodiments. The capability report may be generated based at least in part on the CJT calibration assistance capability support inquiry.

In some embodiments, the message may be a preference feedback message. The preference feedback message may be generated based at least in part on an SINR, an SNR, an RSRP, a charge status, a mobility status, or a channel status. In some embodiments, the procedure 1000 may include identifying an RRC reconfiguration message that includes an otherConfig information element. The preference feedback message may be generated in accordance with information within the otherConfig information element.

In some embodiments, the preference feedback message may be a first preference feedback message. The procedure 1000 may further include initiating a count of a prohibition timer at transmission of the calibration report in some embodiments. The procedure 1000 may further include determining a preference for supporting CJT calibration assistance after expiration of the prohibition timer. The procedure 1000 may further include generating a second preference feedback message for transmission to the base station. The second preference feedback message may indicate the preference for supporting CJT calibration assistance.

Any one or more of the operations in FIG. 10 may be performed in a different order than shown and/or one or more of the operations may be performed concurrently in embodiments. Further, it should be understood that one or more of the operations may be omitted from and/or one or more additional operations may be added to the procedure 1000 in other embodiments.

FIG. 11 illustrates an example UE 1100 in accordance with some embodiments. The UE 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1100 may be a RedCap UE or NR-Light UE.

The UE 1100 may include processors 1104, RF interface circuitry 1108, memory/storage 1112, user interface 1116, sensors 1120, driver circuitry 1122, power management integrated circuit (PMIC) 1124, antenna structure 1126, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1132, which may represent any type of interface, input/output, bus (local, system, or expansion), transmission line, trace, optical connection, etc. that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform operations as described herein.

In some embodiments, the baseband processor circuitry 1104A may access a communication protocol stack 1136 in the memory/storage 1112 to communicate over a 3GPP compatible network. In general, the baseband processor circuitry 1104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1112 may include one or more non-transitory, computer-readable media that includes instructions (for example, communication protocol stack 1136) that may be executed by one or more of the processors 1104 to cause the UE 1100 to perform various operations described herein. The memory/storage 1112 include any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1108 may include transceiver circuitry and radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1126 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1126.

In various embodiments, the RF interface circuitry 1108 may be configured to transmit/receive signals in a manner compatible with NR access technologies.

The antenna structure 1126 may include antenna elements to convert electrical signals into radio waves to travel through the air and to convert received radio waves into electrical signals. The antenna elements may be arranged into one or more antenna panels. The antenna structure 1126 may have antenna panels that are omnidirectional, directional, or a combination thereof to enable beamforming and multiple input, multiple output communications. The antenna structure 1126 may include microstrip antennas, printed antennas fabricated on the surface of one or more printed circuit boards, patch antennas, phased array antennas, etc. The antenna structure 1126 may have one or more panels designed for specific frequency bands including bands in FR1 or FR2.

The user interface 1116 includes various input/output (I/O) devices designed to enable user interaction with the UE 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of sensor circuitry 1120 and control and allow access to sensor circuitry 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the UE 1100. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1100 may power down for brief intervals of time and thus save power. If there is no data traffic activity for an extended period of time, then the UE 1100 may transition off to an RRC_Idle state, where it disconnects from the network and does not perform operations such as channel quality feedback, handover, etc. The UE 1100 goes into a very low power state and it performs paging where again it periodically wakes up to listen to the network and then powers down again. The UE 1100 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1128 may power the UE 1100, although in some examples the UE 1100 may be mounted deployed in a fixed location, and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

FIG. 12 illustrates an example base station 1200 in accordance with some embodiments. In some embodiments, the base station 1200 may be a next generation nodeB (base station). The base station 1200 may include processors 1204, RF interface circuitry 1208, core network (CN) interface circuitry 1212, memory/storage circuitry 1216, and antenna structure 1226.

The components of the base station 1200 may be coupled with various other components over one or more interconnects 1228.

The processors 1204, RF interface circuitry 1208, memory/storage circuitry 1216 (including communication protocol stack 1210), antenna structure 1226, and interconnects 1228 may be similar to like-named elements shown and described with respect to FIG. 11.

The CN interface circuitry 1212 may provide connectivity to a core network, for example, a 5th Generation Core network (5GC) using a 5GC-compatible network interface protocol such as carrier Ethernet protocols, or some other suitable protocol. Network connectivity may be provided to/from the base station 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying a channel state information (CSI)-reference signal (RS) transmission configuration for coherent joint transmission (CJT) calibration assistance received from a base station, performing measurements in accordance with the CSI-RS transmission configuration for CJT calibration, and generating a calibration report indicating results of the measurements for CJT calibration for transmission to the base station.

Example 2 may include the method of example 1, further comprising identifying a calibration report resource configuration received from the base station, wherein the calibration report is generated in accordance with the calibration report resource configuration.

Example 3 may include the method of example 1, further comprising identifying a CJT calibration assistance capability support inquiry received from the base station, determining a capability to support CJT calibration assistance, and generating a capability report indicating capability to support CJT calibration assistance.

Example 4 may include the method of example 1, further comprising determining a preference for supporting CJT calibration assistance, and generating a preference feedback message for transmission to the base station, the preference feedback message indicating the preference for supporting CJT calibration assistance.

Example 5 may include the method of example 4, wherein determining the preference includes determining the preference based at least in part on a signal to interference and noise ratio (SINR), a signal to noise ratio (SNR), a charge status, a mobility status, or a channel status.

Example 6 may include the method of example 5, wherein the preference for supporting CJT calibration assistance is a first preference for supporting CJT calibration assistance, wherein the preference feedback message is a first preference feedback message, and wherein the method further comprises initiating a count of a prohibition timer at transmission of the calibration report, determining a second preference for supporting CJT calibration assistance after expiration of the prohibition timer, and generating a second preference feedback message for transmission to the base station, the second preference feedback message indicating the second preference for supporting CJT calibration assistance.

Example 7 may include the method of example 5, further comprising identifying a radio resource control (RRC) reconfiguration message that includes an otherConfig information element, wherein the preference feedback message is generated in accordance with information within the otherConfig information element.

Example 8 may include the method of example 1, further comprising identifying an event occurrence, and generating a preference feedback message for transmission to the base station in response to the event occurrence, the preference feedback message indicating support for CJT calibration assistance.

Example 9 may include the method of example 8, wherein the event occurrence includes a mobility status below a first threshold, a signal to interference and noise ratio (SINR) above a second threshold, a signal to noise ratio (SNR) above a third threshold, or a reference signal received power (RSRP) above a fourth threshold.

Example 10 may include the method of example 1, wherein the measurements include time/delay measurements per transmission and reception point (TRP) or frequency offset measurements per TRP.

Example 11 may include a method comprising generating a channel state information (CSI)-reference signal (RS) transmission configuration for coherent joint transmission (CJT) calibration assistance for transmission to a UE, and identifying a calibration report received from the UE, information from the calibration report to be utilized for calibrating one or more transmission and reception points (TRPs).

Example 12 may include the method of example 11, further comprising generating a calibration report resource configuration for transmission to the UE, wherein the calibration report is generated in accordance with the calibration report resource configuration.

Example 13 may include the method of example 11, further comprising generating a CJT calibration assistance capability support inquiry for transmission to the UE, and identifying a capability report received from the UE, the capability report indicating that the UE is capable of supporting CJT calibration assistance, wherein the CSI-RS transmission configuration is generated based at least in part on the capability report.

Example 14 may include the method of example 11, further comprising identifying a preference feedback message received from the UE, the preference feedback message indicating that the UE is available for CJT calibration assistance, wherein the CSI-RS transmission configuration is generated based at least in part on the preference feedback message.

Example 15 may include the method of example 14, further comprising generating a radio resource control (RRC) reconfiguration message that includes an otherConfig information element for transmission to the UE, the otherConfig information element to configure the UE for preference feedback.

Example 16 may include the method of example 15, wherein the otherConfig information element includes a prohibition timer configuration.

Example 17 may include the method of example 11, further comprising identifying one or more user equipments (UEs) available for CJT calibration assistance, and selecting the UE from the one or more UEs for calibrating one or more TRPs based at least in part on timing advance (TA) values of the UE for the one or more TRPs, wherein the CSI-RS transmission configuration is generated based at least in part on the UE being selected.

Example 18 may include a method comprising generating a message that indicates coherent joint transmission (CJT) calibration assistance is supported, the message for transmission to a base station, identifying a channel state information (CSI)-reference signal (RS) transmission configuration for CJT calibration assistance received from the base station, and generating a calibration report for transmission to the base station, the calibration report including information for CJT calibration.

Example 19 may include the method of example 18, further comprising performing measurements in accordance with the CSI-RS transmission configuration for CJT calibration to produce the information included in the calibration report.

Example 20 may include the method of example 18, wherein the message is a capability report, and wherein the method further comprises identifying a CJT calibration assistance capability support inquiry received from the base station, wherein the capability report is generated based at least in part on the CJT calibration assistance capability support inquiry.

Example 21 may include the method of example 18, wherein the message is a preference feedback message, and wherein the preference feedback message in generated based at least in part on a signal to inference and noise ratio (SINR), a signal to noise ratio (SNR), a charge status, a mobility status, or a channel status.

Example 22 may include the method of example 21, further comprising identifying a radio resource control (RRC) reconfiguration message that includes an otherConfig information element, wherein the preference feedback message is generated in accordance with information within the otherConfig information element.

Example 23 may include the method of example 21, wherein the preference feedback message is a first preference feedback message, and wherein the method further comprises initiating a count of a prohibition timer at transmission of the calibration report, determining a preference for supporting CJT calibration assistance after expiration of the prohibition timer, and generating a second preference feedback message for transmission to the base station, the second preference feedback message indicating the preference for supporting CJT calibration assistance.

Example 24 may include the method of example 18, wherein the message is a preference feedback message, and wherein the method further comprises identifying an event occurrence, the preference feedback message being generated based at least in part on the event occurrence.

Example 25 may include the method of example 24, wherein the event occurrence includes a mobility status below a first threshold, a signal to interference and noise ratio (SINR) above a second threshold, a signal to noise ratio (SNR) above a third threshold, or a reference signal received power (RSRP) above a fourth threshold.

Example 26 may include an apparatus comprising means to perform one or more elements of a method described in or related to any of examples 1-25, or any other method or process described herein.

Example 27 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example 28 may include an apparatus comprising logic, modules, or circuitry to perform one or more elements of a method described in or related to any of examples 1-25, or any other method or process described herein.

Example 29 may include a method, technique, or process as described in or related to any of examples 1-25, or portions or parts thereof.

Example 30 may include an apparatus comprising: one or more processors and one or more computer-readable media comprising instructions that, when executed by the one or more processors, cause the one or more processors to perform the method, techniques, or process as described in or related to any of examples 1-25, or portions thereof.

Example 31 may include a signal as described in or related to any of examples 1-25, or portions or parts thereof.

Example 32 may include a datagram, information element, packet, frame, segment, PDU, or message as described in or related to any of examples 1-25, or portions or parts thereof, or otherwise described in the present disclosure.

Example 33 may include a signal encoded with data as described in or related to any of examples 1-25, or portions or parts thereof, or otherwise described in the present disclosure.

Example 34 may include a signal encoded with a datagram, IE, packet, frame, segment, PDU, or message as described in or related to any of examples 1-25, or portions or parts thereof, or otherwise described in the present disclosure.

Example 35 may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Example 36 may include a computer program comprising instructions, wherein execution of the program by a processing element is to cause the processing element to carry out the method, techniques, or process as described in or related to any of examples 1-25, or portions thereof.

Example 37 may include a signal in a wireless network as shown and described herein.

Example 38 may include a method of communicating in a wireless network as shown and described herein.

Example 39 may include a system for providing wireless communication as shown and described herein.

Example 40 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify a channel state information (CSI)-reference signal (RS) transmission configuration for coherent joint transmission (CJT) calibration assistance received from a base station;
perform measurements in accordance with the CSI-RS transmission configuration for CJT calibration; and
generate a calibration report indicating results of the measurements for CJT calibration for transmission to the base station.

2. The one or more non-transitory, computer-readable media of claim 1, wherein the instructions, when executed, further cause the processing circuitry to:
identify a calibration report resource configuration received from the base station, wherein the calibration report is generated in accordance with the calibration report resource configuration.

3. The one or more non-transitory, computer-readable media of claim 1, wherein the instructions, when executed, further cause the processing circuitry to:
identify a CJT calibration assistance capability support inquiry received from the base station;
determine a capability to support CJT calibration assistance; and
generate a capability report indicating capability to support CJT calibration assistance.

4. The one or more non-transitory, computer-readable media of claim 1, wherein the instructions, when executed, further cause the processing circuitry to:
determine a preference for supporting CJT calibration assistance; and
generate a preference feedback message for transmission to the base station, the preference feedback message indicating the preference for supporting CJT calibration assistance.

5. The one or more non-transitory, computer-readable media of claim 4, wherein determining the preference includes determining the preference based at least in part on a signal to interference and noise ratio (SINR), a signal to noise ratio (SNR), a charge status, a mobility status, or a channel status.

6. The one or more non-transitory, computer-readable media of claim 5, wherein the preference for supporting CJT calibration assistance is a first preference for supporting CJT calibration assistance, wherein the preference feedback message is a first preference feedback message, and wherein the instructions, when executed, further cause the processing circuitry:
initiate a count of a prohibition timer at transmission of the calibration report;
determine a second preference for supporting CJT calibration assistance after expiration of the prohibition timer; and
generate a second preference feedback message for transmission to the base station, the second preference feedback message indicating the second preference for supporting CJT calibration assistance.

7. The one or more non-transitory, computer-readable media of claim 1, wherein the instructions, when executed, further cause the processing circuitry:
identify an event occurrence; and
generate a preference feedback message for transmission to the base station in response to the event occurrence, the preference feedback message indicating support for CJT calibration assistance.

8. The one or more non-transitory, computer-readable media of claim 7, wherein the event occurrence includes a mobility status below a first threshold, a signal to interference and noise ratio (SINR) above a second threshold, a signal to noise ratio (SNR) above a third threshold, or a reference signal received power (RSRP) above a fourth threshold.

9. A method comprising:
generating a channel state information (CSI)-reference signal (RS) transmission configuration for coherent joint transmission (CJT) calibration assistance for transmission to a user equipment (UE); and
identifying a calibration report received from the UE, information from the calibration report to be utilized for calibrating one or more transmission and reception points (TRPs).

10. The method of claim 9, further comprising:
generating a calibration report resource configuration for transmission to the UE, wherein the calibration report is generated in accordance with the calibration report resource configuration.

11. The method of claim 9, further comprising:
generating a CJT calibration assistance capability support inquiry for transmission to the UE; and
identifying a capability report received from the UE, the capability report indicating that the UE is capable of supporting CJT calibration assistance, wherein the CSI-RS transmission configuration is generated based at least in part on the capability report.

12. The method of claim 9, further comprising:
identifying a preference feedback message received from the UE, the preference feedback message indicating that the UE is available for CJT calibration assistance, wherein the CSI-RS transmission configuration is generated based at least in part on the preference feedback message.

13. The method of claim 12, further comprising:
generating a radio resource control (RRC) reconfiguration message that includes an otherConfig information element for transmission to the UE, the otherConfig information element to configure the UE for preference feedback.

14. The method of claim 9, further comprising:
identifying one or more user equipments (UEs) available for CJT calibration assistance; and
selecting the UE from the one or more UEs for calibrating one or more TRPs based at least in part on timing advance (TA) values of the UE for the one or more TRPs, wherein the CSI-RS transmission configuration is generated based at least in part on the UE being selected.

15. An apparatus comprising:
processing circuitry to:
generate a message that indicates coherent joint transmission (CJT) calibration assistance is supported, the message for transmission to a base station;
identify a channel state information (CSI)-reference signal (RS) transmission configuration for CJT calibration assistance received from the base station; and
generate a calibration report for transmission to the base station, the calibration report including information for CJT calibration; and
interface circuitry coupled with the processing circuitry, the interface circuitry to enable communication.

16. The apparatus of claim 15, wherein the processing circuitry is further to:
perform measurements in accordance with the CSI-RS transmission configuration for CJT calibration to produce the information included in the calibration report.

17. The apparatus of claim 15, wherein the message is a capability report, and wherein the processing circuitry is further to:
identify a CJT calibration assistance capability support inquiry received from the base station, wherein the capability report is generated based at least in part on the CJT calibration assistance capability support inquiry.

18. The apparatus of claim 15, wherein the message is a preference feedback message, and wherein the preference feedback message in generated based at least in part on a signal to inference and noise ratio (SINR), a signal to noise ratio (SNR), a charge status, a mobility status, or a channel status.

19. The apparatus of claim 18, wherein the processing circuitry is further to:
identify a radio resource control (RRC) reconfiguration message that includes an otherConfig information element, wherein the preference feedback message is generated in accordance with information within the otherConfig information element.

20. The apparatus of claim 18, wherein the preference feedback message is a first preference feedback message, and wherein the processing circuitry is further to:
initiate a count of a prohibition timer at transmission of the calibration report;
determine a preference for supporting CJT calibration assistance after expiration of the prohibition timer; and
generate a second preference feedback message for transmission to the base station, the second preference feedback message indicating the preference for supporting CJT calibration assistance.
